(19) United States
(12) Patent Application Publication
(10) Pub. No.: US 2003/0178850 A1
(43) Pub. Date: Sep. 25, 2003

(54) Pipe coupling with V-shaped tongue and recess

(76) Inventors: Douglas R. Dole, Whitehouse Station, NJ (US); William A. Nagle, Laureldale, PA (US)

Correspondence Address: John A. Chionchio, Esquire, Synnestvedt & Lechner LLP, Suite 2600, 1101 Market Street, Philadelphia, PA, 19107-2950, US

(21) Appl. No.: 10/101,893

(22) Filed: Mar. 20, 2002

(51) Int. Cl. F16L 25/00

(52) U.S. Cl. 285/420

(57) ABSTRACT

A coupling for axially joining pipe ends together is disclosed. The coupling is divided into a pair of coupling portions which clamp around the pipe ends opposite one another. Each coupling portion has a pair of keys which engage circumferential grooves in the surfaces of the pipe ends. Each coupling portion has a free end with a V-shaped tongue extending therefrom and an opposite free end with a V-shaped recess. When clamped around the pipe ends, the V-shaped tongue on one coupling portion engages the V-shaped recess on the other coupling portion. The tongues each have an apex and the recesses each have a vertex which may be offset from the centerline of the coupling.

### FIELD OF THE INVENTION

This invention relates to couplings for joining pipes together and especially to couplings for use with pipes having circumferential grooves.

### BACKGROUND OF THE INVENTION

Mechanical pipe couplings are used extensively throughout industry and in the construction trades for sealingly joining pipe ends together to form piping networks carrying various fluids such as liquids and gases safely, economically and reliably. FIGS. 1 and 2 illustrate an example of a prior art pipe coupling 10 currently in use, for example, to construct a piping network for a fire suppression sprinkler system in an office building or warehouse.

As shown in FIG. 1, coupling 10 comprises two coupling portions 12 and 14 engageable with one another to effect a fluid-tight pipe joint 16 shown in FIG. 2. Pipe coupling portions 12 and 14 are substantially arcuate in shape and each has a pair of keys 18 and 20 positioned in spaced relation from one another on either side of each coupling portion. Keys 18 and 20 each have an arcuate surface 22 facing radially inwardly. Surfaces 22 have a width 24 sized to interfit within a circumferential groove 26 on a pipe end 28 (FIG. 2). The coupling portions 12 and 14 are clamped around the pipe ends as shown in FIG. 2. The couplings are toleranced such that arcuate surfaces 22 engage the outer surface 30 of the pipe end 28 within grooves 26 when the joint 16 is formed. Keys 18 and 20 may also engage annular side surfaces (not shown) of the groove to limit axial motion of the pipe ends relative to the coupling.

A void 32 is positioned between the keys 18 and 20 on each coupling portion 12 and 14. Void 32 extends circumferentially around each coupling portion and provides a space to receive a sealing member, such as the circular elastomeric seal 34. Seal 34 is compressed between the coupling portions 12 and 14 and the pipe end 28 at the pipe joint 16 to seal the joint.

Each coupling portion 12 and 14 has two free ends 36 and 38. Each free end 36 on a coupling portion engages a free end 38 on the other coupling portion when the coupling portions are clamped around the pipe ends to form the joint as shown in FIG. 2. Each coupling portion also has a lug 40 positioned at each of the free ends 36 and 38. The lugs extend outwardly from the coupling portions and provide bearing surfaces 42 having holes 44 which receive fasteners such as bolts 46 and nuts 48. The fasteners engage the bearing surfaces 42 and attach the coupling portions to one another circumferentially around the pipe ends 28 on opposite sides thereof as shown in FIG. 2.

It is advantageous to provide a tongue 50 extending from each of free ends 36 and a recess 52 positioned at each of free ends 38, the recesses 52 being adapted to receive the tongues 50 when the coupling portions 12 and 14 are joined at their free ends as shown in FIG. 2. The tongue 50 and recess 52 help prevent the elastomeric seal 34 from being extruded out of the coupling 10 through a gap 54 which forms at the free ends 36 and 38 between the coupling portions 12 and 14. Gap 54 is usually present due to the fact that the dimensions of the keys 18 and 20 are toleranced so that arcuate surfaces 22 engage the outer surface of the pipe being joined so that the clamping force exerted by the bolts 46 and nuts 48 clamps the coupling portions to the pipes and not the coupling portions to one another. Gap 54 must be present to ensure that there is no interference at the interfacing free ends 36 and 38 preventing clamping of the coupling portions onto the pipe. Seal 34 may be under considerable pressure when the joint carries fluid, and a large gap 54 will allow the elastomeric material to be extruded outwardly from the joint to burst and cause joint leakage.

The tongue and recess also prevent the joint from being easily damaged by the insertion of a sharp object, such as a knife blade, through the gap 54 to intentionally puncture the seal, thus, preventing sabotage to the piping network or theft of the fluid flowing within the pipes.

There are, however, disadvantages to using the tongue and recess on the pipe coupling portions. For example, when preparing a pipe joint the coupling portions must be forced over the elastomeric seal 34, which is compressed between the coupling portions and the pipe ends to effect a seal. During this procedure, the tongue 50 contacts the circumference of the seal and causes it to bulge outwardly in front of the tongue. As the tongue mates with the recess, the bulge may be pinched between the tongue and the recess, damaging the seal. Furthermore, it is possible for a careless technician to join the coupling portions 12 and 14 with a tongue against a tongue and a recess against a recess by reversing one of the coupling portions. Since the coupling portions will still remain relatively square to one another, such a mistake could go undetected until the piping network is pressurized with fluid and leaks appear or joint separation occurs at such ill formed joints.

There is clearly a need for a pipe coupling which possesses the advantages of the tongue and recess construction but does not suffer its disadvantages.

### SUMMARY AND OBJECTS OF THE INVENTION

The invention concerns a coupling for joining together a pair of pipe ends in coaxial engagement. Each pipe end has a circumferential groove formed in an outer surface thereof. Each groove is defined by a pair of annular side surfaces arranged in spaced relation and facing one another. The coupling comprises first and second coupling portions. Each coupling portion has an arcuate shape substantially conforming to the shape of the pipe ends. The first portion has a free end comprising a V-shaped tongue extending therefrom, and the second portion has a free end comprising a V-shaped recess oriented for receiving the V-shaped tongue. The first and second portions are circumferentially positionable about the pipe ends on opposite sides thereof with the V-shaped tongue interfitting within the V-shaped recess.

The coupling also includes a pair of keys positioned in spaced relation to one another on each side of each of the coupling portions. Each of the keys comprises a first arcuate surface facing substantially radially inwardly from the coupling portion and having a width sized to interfit within the groove between the annular side surfaces on one of the pipe ends when the coupling portions are circumferentially positioned about the pipe ends. The first arcuate surface is circumferentially engageable with the outer surface of the pipe within the groove. Means are provided for attaching the first and the second coupling portions to one another when circumferentially positioned about the pipe ends. The preferred attachment means comprises lugs extending from the coupling portions and fasteners passing between the lugs.

Preferably, both the first and the second coupling portions have two free ends, one of the free ends on each coupling portion comprising the V-shaped tongue and the other of the free ends comprising the V-shaped recess for receiving the V-shaped tongue. The first and second coupling portions are engageable around the pipe ends with the V-shaped tongue on each of the coupling portions engaging the V-shaped recess on each of the coupling portions.

In an embodiment of the coupling according to the invention, the V-shaped tongue on the first coupling portion has an apex offset toward one side of the coupling portion. Similarly, the V-shaped recess on the second coupling portion also has an apex offset toward the same side so as to permit engagement of the offset V-shaped tongue on the first coupling portion with the offset V-shaped recess on the second coupling portion when the coupling portions are circumferentially positioned about the pipe ends.

When the V-shaped tongue is offset on the first coupling portion, it is also preferred that the V-shaped recess on the first coupling portion have an apex offset toward the same side of the coupling portion. Similarly, the V-shaped tongue on the second coupling portion also has an apex offset toward the same side of the coupling portion so as to permit engagement of the offset V-shaped tongue on the second coupling portion with the offset V-shaped recess of the first coupling portion when the coupling portions are circumferentially positioned about the pipe ends.

It is an object of the invention to provide a pipe coupling for grooved pipes having two coupling portions which interface at a free end by a tongue extending from the free end and being received within a recess in the other free end, the tongue and recess having complementary V-shapes.

It is another object of the invention to provide a pipe coupling wherein the tongue has an apex offset to one side of the coupling and the recess has a vertex offset to the same side of the coupling.

It is still another object of the invention to provide a pipe coupling having tongues and recesses but which reduce the likelihood that the seal will be pinched and damaged between the tongue and recess.

It is yet another object of the invention to provide a pipe coupling which has two coupling portions which are difficult to mate together incorrectly.

It is again another object of the invention to provide a pipe coupling which has coupling portions which are difficult to mismatch with other coupling portions of similar appearance and size but manufactured to different pipe diameter specifications.

These and other objects and advantages of the invention will be apparent upon consideration of the following drawings and detailed description of preferred embodiments.

### BRIEF DESCRIPTION OF THE DRAWINGS

FIG. 1 is an exploded perspective view of a prior art pipe coupling;

FIG. 2 is a cross-sectional view of the prior art pipe coupling depicted in FIG. 1 engaging a pipe end;

FIG. 3 is a pipe coupling according to the invention joining two pipe ends together, the pipe ends being shown in phantom line;

FIG. 4 is an exploded perspective view of the pipe coupling shown in FIG. 3;

FIG. 5 is a cross-sectional view taken along lines 5-5 in FIG. 3;

FIG. 6 is a longitudinal sectional view taken along lines 6-6 of FIG. 5;

FIG. 7 is a partial sectional view taken along line 7-7 of FIG. 6; and

FIGS. 8 and 9 are side views of two embodiments of the invention, the views depicting the same side of each embodiment.

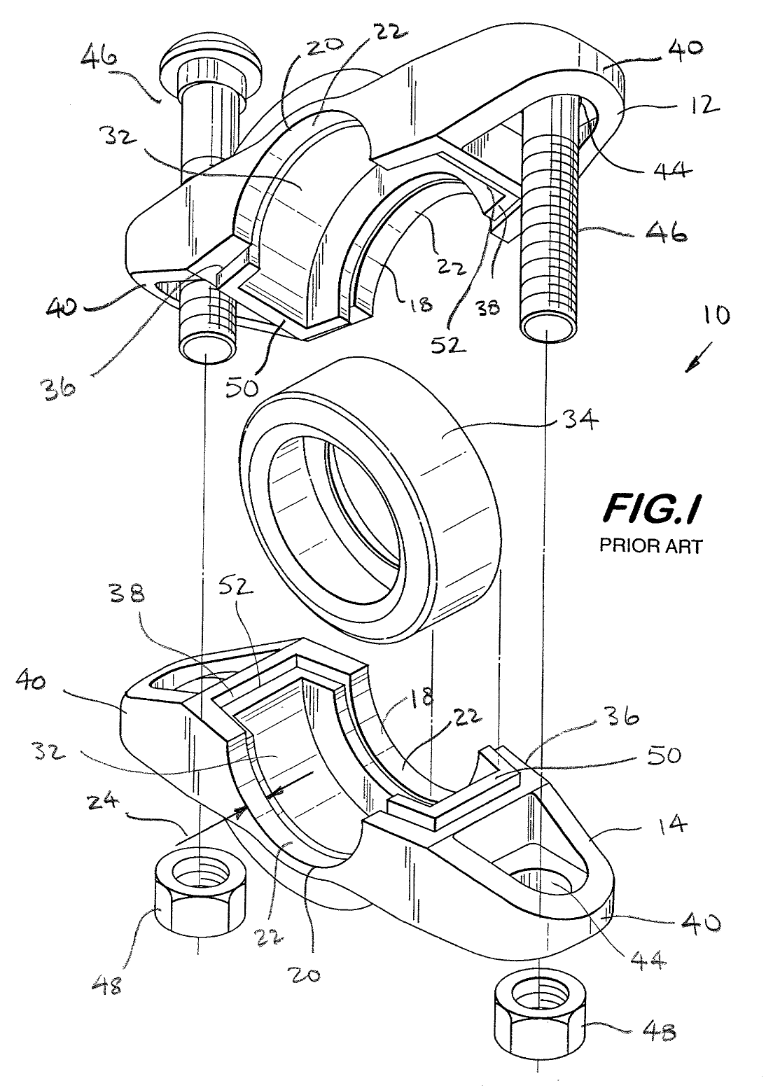

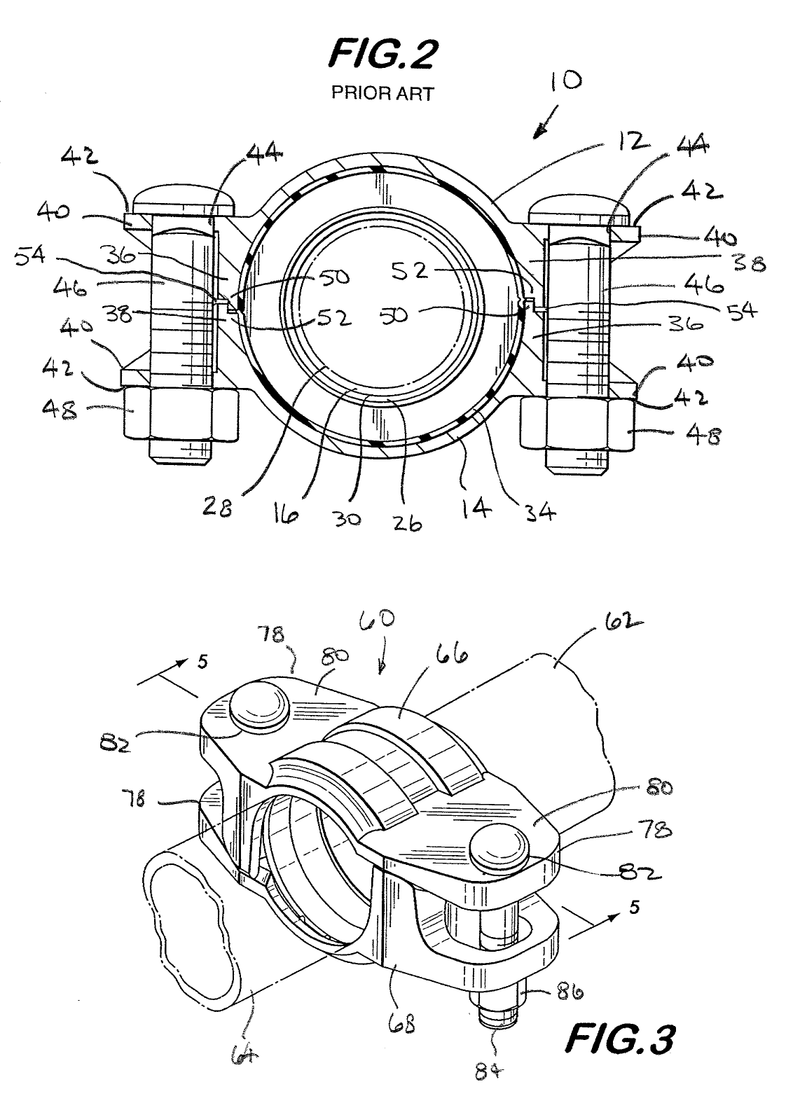

### DETAILED DESCRIPTION OF THE PREFERRED EMBODIMENTS

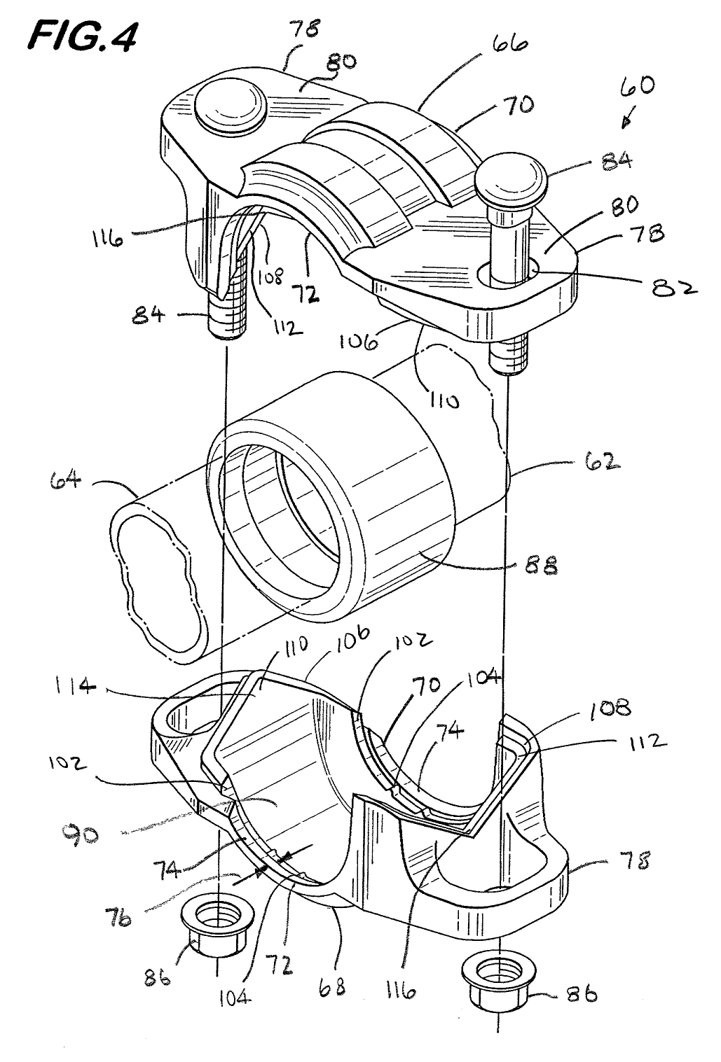

FIG. 3 shows a pipe coupling 60 according to the invention. Coupling 60 joins two pipe ends 62 and 64 together to create a fluid-tight joint in a piping network. As best shown in FIG. 4, coupling 60 comprises two coupling portions 66 and 68 generally arcuate in shape. Each coupling portion has a pair of keys 70 and 72 positioned in spaced relation to one another on each side of the coupling portions. Keys 70 and 72 each have an arcuate surface 74 which faces substantially radially inwardly and has a width 76 sized to interfit within grooves in the pipe ends 62 and 64 as described below.

As shown in FIGS. 3 and 4, the coupling 60 is clamped circumferentially around pipe ends 62 and 64 with each coupling portion opposite the other. The preferred means for clamping attachment is through lugs 78 which extend outwardly in pairs from each coupling portion. Each lug 78 provides a bearing surface 80 with an aperture 82 adapted to receive a fastener, such as the bolt 84 and nut 86 which provide for clamping attachment of the coupling portions 66 and 68 around the pipe ends. Other clamping attachment means include providing a hinge at a free end to pivotally join the coupling portions together and using a bolt and nut with lugs at the other free end to effect coupling about the pipe ends.

To ensure a fluid-tight seal between the pipe ends, a sealing member, such as the circular elastomeric seal 88, is positioned in a void 90 located between the keys 70 and 72 on both coupling portions 66 and 68. As shown in FIG. 6, seal 88 is compressed between the coupling portions 66 and 68 and the outer surface 92 of the pipe ends 62 and 64. Seal 88 preferably has glands 88a which are pressurized by the fluid within the pipe to effect the fluid-tight joint at the pipe ends.

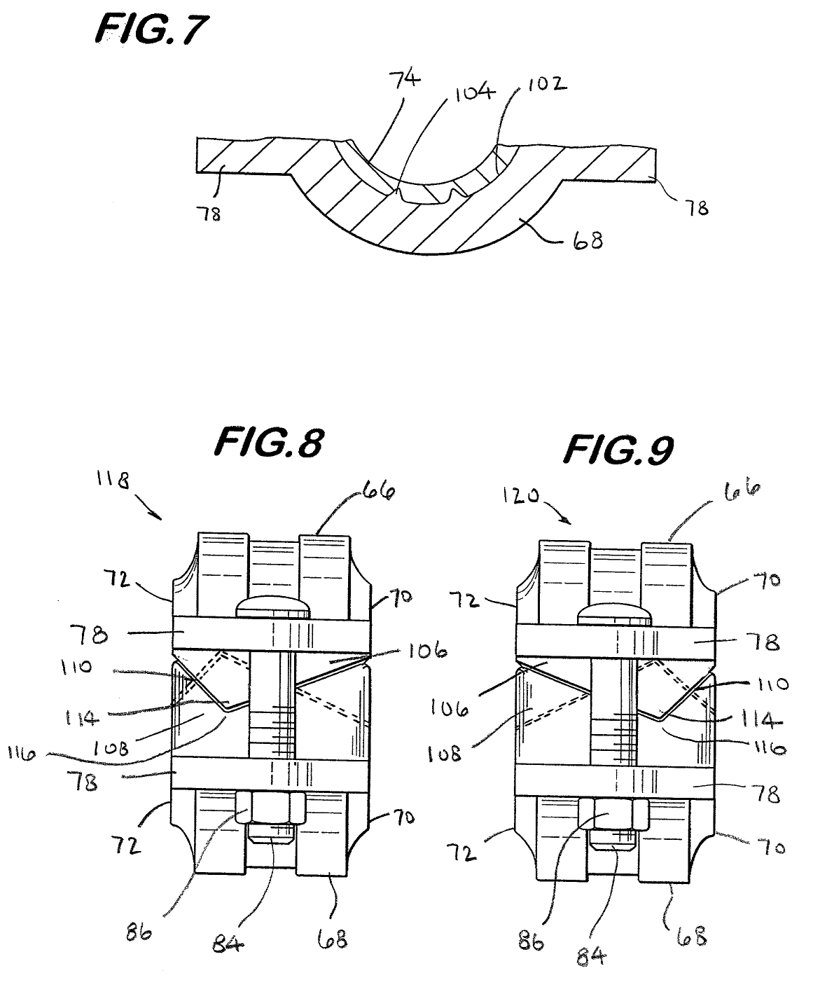

As further shown in FIG. 6, keys 70 and 72 fit within grooves 94 and 96 formed in the outer surface of pipe ends 62 and 64. Each groove is defined by a pair of annular side surfaces 98 and 100, the side surfaces being arranged in spaced relation to and facing one another. The width 76 of keys 70 and 72 is sized to fit between the side surfaces 98 and 100 and allow the arcuate surfaces 74 of the keys to engage the outer surface 92 of the pipe within each groove 94 and 96. The keys also engage the innermost annular side surfaces 100 to prevent the pipe ends from blowing out of the coupling 10 when the joint is under pressure. Preferably, as shown in FIGS. 4 and 7, there is a second arcuate surface 102 positioned adjacent to each arcuate surface 74. Second arcuate surfaces 102 face radially inwardly but are displaced radially outwardly away from arcuate surfaces 74. One or more teeth 104 extend radially inwardly from the second arcuate surfaces and engage the pipe outer surface and the annular side surfaces 100 on pipe ends 62 and 64. The teeth dig into the pipe under the clamping force of the coupling portions and prevent the pipe ends from rotating relatively to the coupling 10.

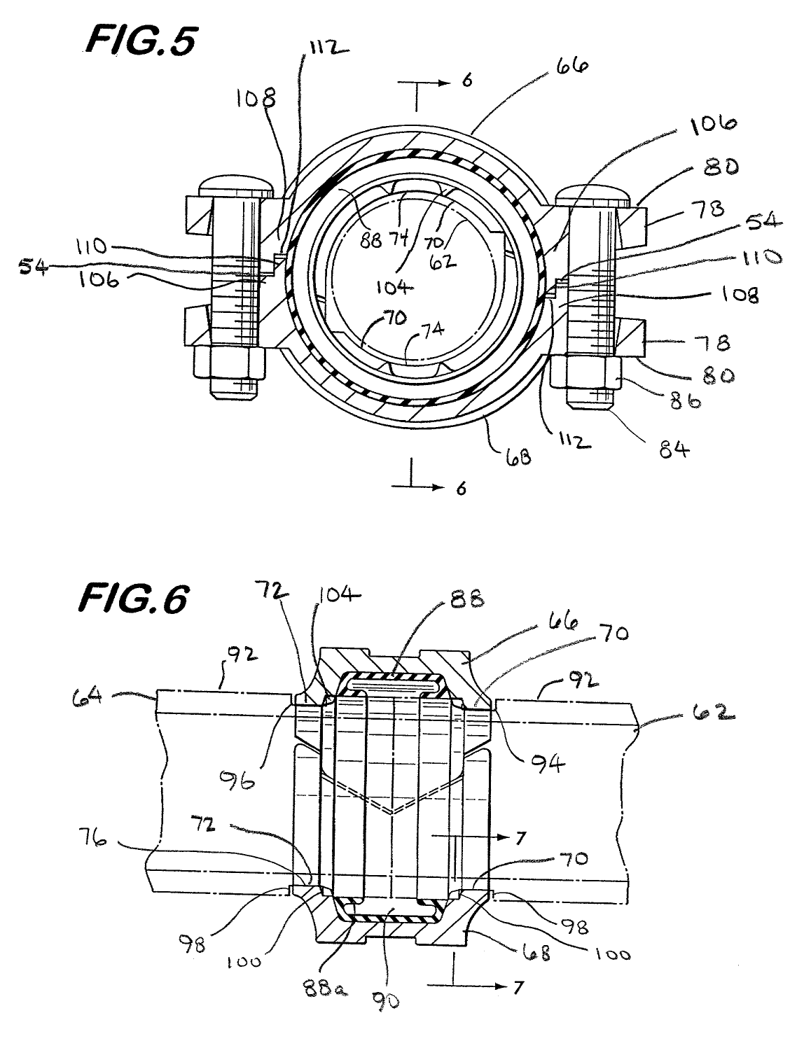

Similar to the prior art coupling described above, each coupling portion 66 and 68 according to the invention preferably has two free ends 106 and 108 best shown in FIG. 4. Free ends 106 on each coupling portion have a V-shaped tongue 110 extending from the free end, and free ends 108 on each coupling have a V-shaped recess 112, oriented to receive the V-shaped tongue. When clamped around the pipe ends 62 and 64, as shown in FIG. 5, free ends 106 on each coupling portion 66 and 68 engage free ends 108, with the V-shaped tongues 110 interfitting within the V-shaped recesses 112. The tongues preferably extend along a curve substantially conforming with the arcuate shape but may also extend tangentially to the free end. The recesses are oriented appropriately to receive the tongues.

The V-shaped tongues and recesses provide the same advantages as the straight profile tongues and recesses described above, (i.e., prevent pressure extrusion or puncture of the sealing member 88 through gap 54) but avoid the disadvantages of mis-mated coupling portions and pinched sealing members.

Properly mated coupling portions, shown in FIG. 5, will have free ends 106 on each coupling portion interfacing with free ends 108 on each coupling portion, resulting in V-shaped tongues 110 being received by V-shaped recesses 112 on both coupling portions. Bearing surfaces 80 on lugs 78 will be substantially parallel with one another and the coupling portions 66 and 68 will fit snugly around the sealing member 88 and clamp onto pipe ends 62 and 64 (not shown). If the coupling portions are mismated, however, with a free end 106 on one coupling portion interfacing with a free end 106 on the other coupling portion, and the free end 108 on one coupling portion interfacing with the free end 108 on the other coupling portion, then the V-shaped tongues will be in contact with one another, the recesses will be facing each other, the bearing surfaces 80 will be skewed relatively to one another and the coupling portions will be kept relatively far apart from one another so that they do not fit snugly around the sealing member 88 and are incapable of clamping around the pipe ends. With such a configuration, it will be immediately obvious that the coupling portions are mismated.

Furthermore, sealing member 88 will tend not to be pinched between the V-shaped tongue 110 and the V-shaped recess 112 as the coupling portions 66 and 68 are assembled onto the sealing member. The apex 114 of the V-shaped tongue 110 (see FIG. 4) tends to compress the circumference of the sealing member at a point and splits the single large bulge which normally occurs in front of the tongue in to two smaller bulges which form on either side of the apex. Because these bulges are smaller, they do not tend to get pinched as the V-shaped tongue is received within the V-shaped recess.

As shown in FIGS. 8 and 9, it is advantageous to offset the apex 114 of tongue 110 from the center to one side or the other of the coupling portions 66 and 68. The vertex 116 of the recess is similarly offset to the same side to permit mating engagement of the tongue and recess. An offset apex and vertex may be positioned on one or both free ends 106 and 108 of the coupling portions and may be to either side of the center. The apex and vertex are preferably spaced from one side or the other of the coupling a distance of approximately ⅓ of the total width of the coupling portions as measured between keys 70 and 72.

One advantage of the offset apex and vertex design is that it allows for immediate differentiation between couplings made to English unit specifications from couplings made to metric unit specifications to avoid improper matching of coupling portions made to different specifications. For example, FIG. 8 shows a coupling 118 having apex 114 and vertex 116 offset to the left of center. FIG. 9 shows a coupling 120 having apex 114 and vertex 116 offset to the right of center. Let the coupling 118 be manufactured to accept a U.S. standard pipe of 2.5 inch nominal diameter (73 mm outside diameter) and let the coupling 120 be manufactured to accept a standard metric pipe having an outer diameter of 76.1 mm. Without offset apices and vertices, these two couplings will be visually undifferentiateable because the pipes they accept are so close in size. Without the offset, it will be easy for a person at the point of manufacture or distribution to improperly match a coupling portion 66 from English unit coupling 118 with a coupling portion 68 from metric unit 120. Such a mismatched coupling will not effect a proper seal in the field when installed on 2.5 inch nominal pipe. It will also be at risk of joint separation under pressure, even though it appears properly installed to the naked eye.

However, by offsetting the apex and vertex to the left for couplings made to English unit specifications and to the right for couplings made to metric specifications the technician can immediately visually discern a mismatched set of coupling portions since couplings with such offsets will not properly engage one another tongue in recess. This can be seen immediately by visually substituting coupling portion 66 from FIG. 9 for coupling portion 66 in FIG. 8.

Couplings according to the invention are preferably cast of ductile iron but may also be made by other techniques such as molding or machining and of other materials such as steel or plastics such as PVC and ABS.

Couplings according to the invention provide several advantages over prior art couplings currently in use including a lower potential for mismating coupling portions during field installation, lower potential for damaging the elastomeric seal within the coupling during installation as well as avoiding improper matching of coupling portions which are close in size but nevertheless designed to different standards. These advantages are provided in addition to the advantages of protecting the seal from extrusion and burst due to high internal pressure, as well as protecting the seal from deliberate or accidental puncture.

What is claimed is:

1. A coupling for joining together a pair of pipe ends in coaxial engagement, each said pipe end having a circumferential groove formed in an outer surface thereof, each said groove being defined by a pair of annular side surfaces arranged in spaced relation and facing one another, said coupling comprising:
first and second coupling portions each having an arcuate shape substantially conforming to said pipe ends, said first coupling portion having a free end comprising a V-shaped tongue extending therefrom, said second coupling portion having a free end comprising a V-shaped recess oriented for receiving said V-shaped tongue, said first and second coupling portions being circumferentially positionable about said pipe ends on opposite sides thereof with said V-shaped tongue interfitting within said V-shaped recess;
a pair of keys positioned in spaced relation to one another on each side of each of said coupling portions, each said key comprising a first arcuate surface facing substantially radially inwardly from said coupling portion and having a width sized to interfit within said groove between said annular side surfaces on one of said pipe ends when said coupling portions are circumferentially positioned about said pipe ends, said first arcuate surface being circumferentially engageable with said outer surface of said pipe within said groove; and
means for attaching said first and said second coupling portions to one another when circumferentially positioned about said pipe ends on opposite sides thereof to join said pipe ends together.

2. A pipe coupling according to claim 1, wherein said V-shaped tongue extends along a curve substantially continuous with said arcuate shape.

3. A pipe coupling according to claim 1, wherein said V-shaped tongue has an apex offset toward one side of said first coupling portion, said V-shaped recess having a vertex also offset toward said one side so as to permit engagement of said V-shaped tongue with said V-shaped recess when said coupling portions are circumferentially positioned about said pipe ends on opposite sides thereof to join said pipe ends together.

4. A coupling according to claim 3, wherein said apex and said vertex are spaced from said one side a distance of approximately ⅓ of the width of said coupling.

5. A pipe coupling according to claim 1, further comprising a void located between said keys on each of said first and second coupling portions, said void extending circumferentially around said coupling portions for accommodating a sealing member positionable between said coupling portions and engageable with said pipe ends for sealingly coupling said pipe ends together.

6. A pipe coupling according to claim 1, wherein each of said first and said second coupling portions has two free ends, one of said free ends on each said coupling portion comprising said V-shaped tongue and the other of said free ends on each said coupling portion comprising said V-shaped recess, said first and second coupling portions being engageable around said pipe ends with said V-shaped tongue on each said coupling portion engaging said V-shaped recess on each said coupling portion.

7. A coupling according to claim 6, wherein said V-shaped tongue on said first coupling portion has an apex offset toward one side thereof, said V-shaped recess on said second coupling portion having a vertex also offset toward said one side so as to permit engagement of said V-shaped tongue on said first coupling portion with said V-shaped recess on said second coupling portion when said coupling portions are circumferentially positioned about said pipe ends on opposite sides thereof to join said pipe ends together.

8. A coupling according to claim 7, wherein said V-shaped recess on said first coupling portion has a vertex offset toward said one side thereof, said V-shaped tongue on said second coupling portion having an apex also offset toward said one side so as to permit engagement of said V-shaped tongue on said second coupling portion with said V-shaped recess of said first coupling portion when said coupling portions are circumferentially positioned about said pipe ends on opposite sides thereof to join said pipe ends together.

9. A coupling according to claim 7, wherein said apex and said vertex are spaced from said one side a distance of approximately ⅓ of the width of said coupling.

10. A pipe coupling according to claim 1, further comprising:
a second arcuate surface facing radially inwardly and positioned adjacent to one of said first arcuate surfaces, said second arcuate surface being displaced radially outwardly from said first arcuate surface and forming a shoulder therebetween; and
a tooth positioned on said second arcuate surface and projecting radially inwardly therefrom, said tooth being engageable with one of said annular side surfaces defining said groove to prevent relative rotation of said pipe end and said coupling when said coupling portions are circumferentially positioned about said pipe ends on opposite sides thereof to join said pipe ends together.

11. A coupling according to claim 1, wherein said attaching means comprises:
a pair of lugs extending outwardly from each of said coupling portions, one lug being positioned adjacent to each of said free ends, each said lug comprising a bearing surface with an aperture therethrough, each of said bearing surfaces on said first coupling portion being in substantially parallel, spaced relation to a respective one of said bearing surfaces on said second coupling portion; and
a pair of fasteners insertable thought said apertures and extending between said lugs on said first and said second coupling portions, said fasteners engaging said bearing surfaces to attach said first and second coupling portions together when positioned on opposite sides of said pipe ends.

12. A coupling for joining together a pair of pipe ends in coaxial engagement, said coupling comprising:
first and second coupling portions each having an arcuate shape substantially conforming to said pipe ends, said first coupling portion having a free end comprising a V-shaped tongue extending therefrom, said second coupling portion having a free end comprising a V-shaped recess oriented for receiving said V-shaped tongue, said first and second coupling portions being circumferentially positionable about said pipe ends on opposite sides thereof with said V-shaped tongue interfitting within said V-shaped recess;
a pair of arcuate surfaces positioned in spaced relation to one another on each side of each of said coupling portions and facing substantially radially inwardly, said arcuate surfaces being circumferentially engageable with said outer surface of said pipe; and
means for attaching said first and said second coupling portions to one another when circumferentially positioned about said pipe ends on opposite sides thereof to join said pipe ends together.

13. A pipe coupling according to claim 12, wherein said V-shaped tongue has an apex offset toward one side of said first coupling portion, said V-shaped recess having a vertex also offset toward said one side so as to permit engagement of said V-shaped tongue with said V-shaped recess when said coupling portions are circumferentially positioned about said pipe ends on opposite sides thereof to join said pipe ends together.

14. A coupling according to claim 13, wherein said apex and said vertex are spaced from said one side a distance of approximately ⅓ of the width of said coupling.

15. A coupling according to claim 12 adapted for coupling pipe ends having a circumferential groove formed in an outer surface thereof, each said groove being defined by a pair of annular side surfaces arranged in spaced relation and facing one another, each said arcuate surface comprising a key having a width sized to interfit within said groove between said annular side surfaces one of said pipe ends when said coupling portions are circumferentially positioned about said pipe ends, said keys being engageable with said annular side surfaces to prevent axial motion of said pipe relatively to said coupling portions when circumferentially positioned about said pipe ends on opposite sides thereof to join said pipe ends together.

16. A pipe coupling according to claim 15, further comprising a void located between said keys on each of said first and second coupling portions, said void extending circumferentially around said coupling portions for accommodating a sealing member positionable between said coupling portions and engageable with said pipe ends for sealingly coupling said pipe ends together.

17. A pipe coupling according to claim 12, wherein each of said first and said second coupling portions has two free ends, one of said free ends on each said coupling portion comprising said V-shaped tongue and the other of said free ends on each said coupling portion comprising said V-shaped recess, said first and second coupling portions being engageable around said pipe ends with said V-shaped tongue on each said coupling portion engaging said V-shaped recess on each said coupling portion.

18. A coupling according to claim 17, wherein said V-shaped tongue on said first coupling portion has an apex offset toward one side thereof, said V-shaped recess on said second coupling portion having a vertex also offset toward said one side so as to permit engagement of said V-shaped tongue on said first coupling portion with said V-shaped recess on said second coupling portion when said coupling portions are circumferentially positioned about said pipe ends on opposite sides thereof to join said pipe ends together.

19. A coupling according to claim 18, wherein said V-shaped recess on said first coupling portion has a vertex offset toward said one side thereof, said V-shaped tongue on said second coupling portion having an apex also offset toward said one side so as to permit engagement of said V-shaped tongue on said second coupling portion with said V-shaped recess of said first coupling portion when said coupling portions are circumferentially positioned about said pipe ends on opposite sides thereof to join said pipe ends together.

20. A coupling according to claim 18, wherein said apex and said vertex are spaced from said one side a distance of approximately ⅓ of the width of said coupling.

21. A pipe coupling according to claim 12, further comprising:
a second arcuate surface facing radially inwardly and positioned adjacent to one of said first named arcuate surfaces, said second arcuate surface being displaced radially outwardly from said one arcuate surface and forming a shoulder therebetween; and
a tooth positioned on said second arcuate surface and projecting radially inwardly therefrom, said tooth being engageable with one of said annular side surfaces defining said groove to prevent relative rotation of said pipe end and said coupling when said coupling portions are circumferentially positioned about said pipe ends on opposite sides thereof to join said pipe ends together.
